(19) United States
(12) Patent Application Publication
(10) Pub. No.: US 2025/0061614 A1
(43) Pub. Date: Feb. 20, 2025

(54) DATA PROCESSING APPARATUS AND DATA PROCESSING METHOD

(71) Applicant: CANON MEDICAL SYSTEMS CORPORATION, Otawara-shi (JP)

(72) Inventor: Hidenori TAKESHIMA, Taito (JP)

(73) Assignee: CANON MEDICAL SYSTEMS CORPORATION, Otawara-shi (JP)

(21) Appl. No.: 18/797,725

(22) Filed: Aug. 8, 2024

(30) Foreign Application Priority Data
Aug. 14, 2023 (JP) 2023-132113

(51) Int. Cl. G06T 11/00; G06V 10/70

(52) U.S. Cl. CPC G06T 11/00; G06T 2210/41; G06T 2210/62; G06V 10/70; G06V 2201/03

(57) ABSTRACT

In one embodiment, a data processing apparatus includes processing circuitry configured to: generate first artificial data; generate second artificial data; generate mixed data by mixing the first artificial data and the second artificial data; and generate mixed region information related to a region where the first artificial data and the second artificial data are mixed.

### CROSS-REFERENCE TO RELATED APPLICATION

This application is based upon and claims the benefit of priority from Japanese Patent Application No. 2023-132113, filed on Aug. 14, 2023, the entire contents of which are incorporated herein by reference.

### FIELD

Disclosed embodiments relate to a data processing apparatus and a data processing method.

### BACKGROUND

In recent years, applications of AI (Artificial Intelligence) technology, particularly technology using machine learning, have been expanding in various image processing including medical image processing and various data processing including medical data.

In the applications of machine learning, a technique called segmentation is known. The segmentation is a technique for identifying or detecting a specific region in an image or segmenting (i.e., dividing) an image into several regions, for example.

The applications of segmentation to the medical field include a known technique for detecting or extracting a desired organ and/or a tumor region from a medical image. For example, an application of the segmentation technique to medical images, such as MR (Magnetic Resonance) images and CT (Computed Tomography) images of the brain, can segment the brain into regions of each brain tissue, such as white matter, gray matter, and cerebrospinal fluid (CSF). The segmentation technique can be used for detecting a suspected tumor region in a medical image obtained by imaging the brain of a patient, or for detecting a heart region in a medical image obtained by imaging the chest.

In machine learning, a trained model is generated by learning in which a large amount of training data are used. For example, to perform image segmentation using machine learning, a large number of real images with added annotations for performing desired segmentation have to be prepared as training data. Adding an annotation to a real image (i.e., to annotate a real image) means, for example, (a) dividing the real image into a plurality of regions different in property and/or (b) extracting a specific region from the real image and then adding information indicating what the extracted region is to the real image.

The processing of adding annotations to data such as real images is almost the same as processing of adding ground truth data or processing of labeling, and such processing is usually performed manually. Thus, preparing a large number of annotated real images (or annotated data) as training data is costly and time-consuming.

### BRIEF DESCRIPTION OF THE DRAWINGS

In the accompanying drawings:

FIG. 1 is a block diagram illustrating a configuration of a data processing apparatus according to the first embodiment;

FIG. 2 is a flowchart illustrating processing to be performed by the data processing apparatus according to the first embodiment;

FIG. 3 is a schematic diagram illustrating a processing concept of the data processing apparatus 1 according to the first embodiment;

FIG. 4 is a block diagram illustrating a configuration of the data processing apparatus according to the second embodiment;

FIG. 5 is a flowchart illustrating processing to be performed by the data processing apparatus according to the second embodiment;

FIG. 6 is a schematic diagram illustrating a processing concept of the data processing apparatus 1 according to the second embodiment;

FIG. 7 is a block diagram illustrating a configuration of the data processing apparatus according to the third embodiment;

FIG. 8 is a flowchart illustrating processing to be performed by the data processing apparatus according to the third embodiment; and

FIG. 9 is a schematic diagram illustrating a processing concept of the data processing apparatus 1 according to the third embodiment.

### DETAILED DESCRIPTION

Hereinbelow, embodiments of the present invention will be described by referring to the accompanying drawings.

In one embodiment, a data processing apparatus includes processing circuitry configured to: generate first artificial data; generate second artificial data; generate mixed data by mixing the first artificial data and the second artificial data; and generate mixed region information related to a region where the first artificial data and the second artificial data are mixed.

### First Embodiment

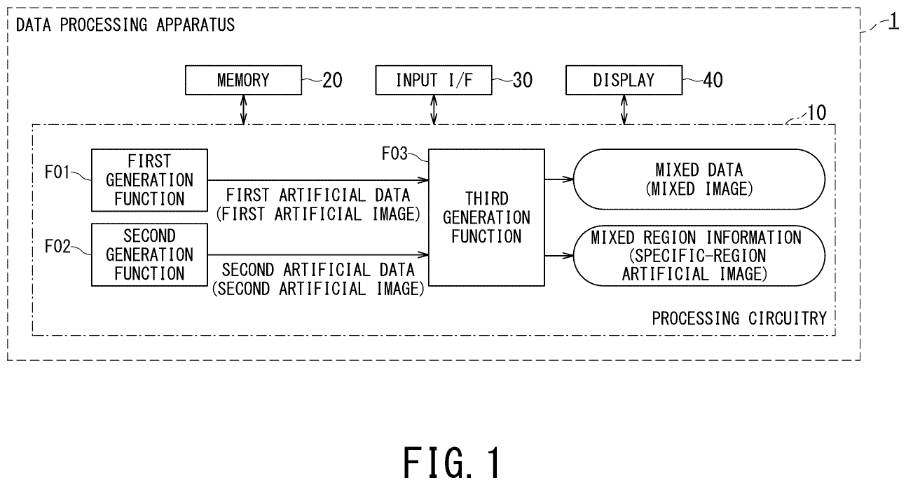

FIG. 1 is a block diagram illustrating a configuration of a data processing apparatus 1 according to the first embodiment.

As shown in FIG. 1, the data processing apparatus 1 according to the first embodiment includes processing circuitry 10, a memory 20, an input I/F (interface) 30, and a display 40.

The processing circuitry 10 includes a special-purpose or general-purpose processor, and implements various functions described below through software processing of executing programs stored in the memory 20. The processing circuitry 10 may include hardware such as an ASIC (Application Specific Integration Circuit) and a programmable logic device, as exemplified by an FPGA (Field Programmable Gate Array). The various functions described below can also be implemented by hardware processing using these components. In addition, the processing circuitry 10 may implement various functions described below by combining software processing and hardware processing.

The input I/F 30 includes an input device that can be operated by a user and an input circuit configured to receive an input signal from the input device. The input device is realized by, for example, a trackball, a switch, a mouse, a keyboard, a touchpad enabling input operations by touching its operating surface, a touchscreen in which a display screen and a touchpad are integrated, a non-contact input device using an optical sensor, and a voice input device.

The display 40 is composed of a general display output device such as a liquid crystal display and an OLED (Organic Light Emitting Diode) display. The display 40 in cooperation with the input I/F 30 constitute a user interface for input and setting of various data and information.

The memory 20 stores various processing programs to be executed by the processing circuitry 10, data necessary for executing the programs, and various images. The memory 20 includes a storage medium readable by the processor, such as a magnetic or optical storage medium and a semiconductor memory.

In addition to the above-described components, the data processing apparatus 1 may include an interface circuit with various telecommunication lines, which include, for example, a wired/wireless LAN, the Internet, a public telephone line, and a close proximity wireless line such as Bluetooth. The data processing apparatus 1 may further include an interface circuit with a disk-type storage medium such as a magnetic disk and an optical disk and a plug-in storage medium such as a USB memory and various memory cards.

As shown in FIG. 1, the processing circuitry 10 includes a first generation function F01, a second generation function F02, and a third generation function F03.

The first generation function F01 generates first artificial data, and the second generation function F02 generates second artificial data. Further, the third generation function F03 generates mixed data by mixing the first artificial data and the second artificial data, and also generates mixed region information related to a region where the first artificial data and the second artificial data are mixed.

As described below, the mixed data and the mixed region information generated by the third generation function F03 are training data for training a machine learning model.

Although the type of data of the first artificial data is, for example, an image (i.e., first artificial image), it is not limited to an image and may also be sound data or character data, for example.

Similarly, the type of data of the second artificial data is, for example, an image (i.e., second artificial image), but it is not limited to an image and may also be sound data or character data, for example.

When the first artificial data are the first artificial image and the second artificial data are the second artificial image, the mixed data generated by the third generation function F03 are a mixed image in which the first artificial image and the second artificial image are mixed.

The mixed region information generated by the third generation function F03 is information indicating a concept related to the region extracted from either the first artificial data or the second artificial data, for example, from the second artificial data. When the first artificial data are the first artificial image and the second the artificial data are the second artificial image, the mixed region information is an image (i.e., specific-region artificial image) in which a specific region in either one of the artificial images, for example, the second artificial image is depicted.

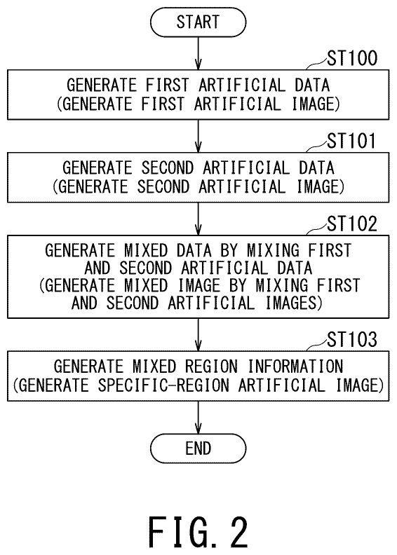

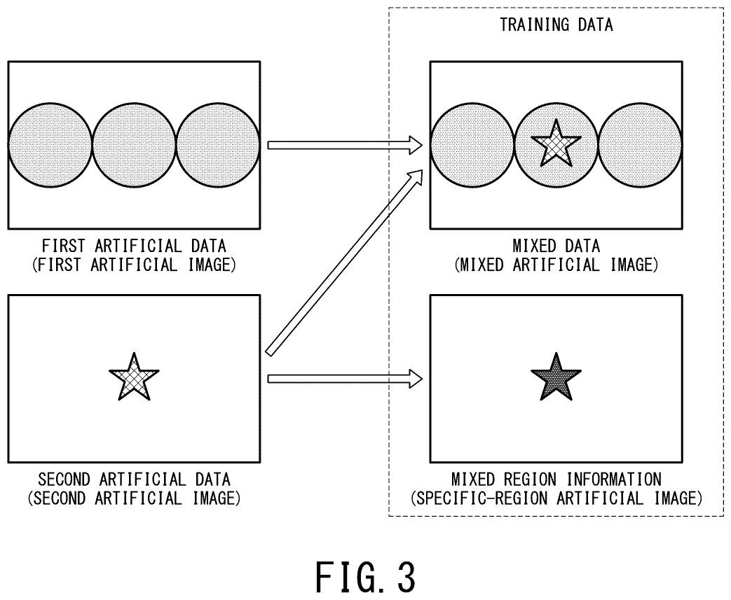

FIG. 2 is a flowchart illustrating processing to be performed by the data processing apparatus 1 according to the first embodiment, and FIG. 3 is a schematic diagram illustrating a processing concept of the data processing apparatus 1 according to the first embodiment.

In the step ST100 of FIG. 2, the first generation function F01 of the processing circuitry 10 generates the first artificial data or the first artificial image.

In the step ST101, the second generation function F02 of the processing circuitry 10 generates the second artificial data or the second artificial image.

In the step ST102, the third generation function F03 of the processing circuitry 10 mixes the first artificial data and the second artificial data to generate the mixed data. Additionally or alternatively, the third generation function F03 of the processing circuitry 10 mixes the first artificial image and the second artificial image to generate the mixed image.

In the step ST103, the third generation function F03 of the processing circuitry 10 further generates the mixed region information or the specific-region artificial image.

The upper left image in FIG. 3 schematically illustrates the first artificial image as the first artificial data. The lower left image in FIG. 3 schematically illustrates the second artificial image as the second artificial data. As illustrated in FIG. 3, the first and second artificial images may be graphic images being far from the real images, or may be artificial images that are similar to the real images. Here, the term “real image” is data obtained by imaging the real world using an arbitrary method, as exemplified by a landscape image, a human image, an animal image, and a medical image. The medical image is obtained by, for example, imaging an object using a medical image diagnostic apparatus such as an MRI apparatus, a CT apparatus, or an ultrasonic diagnostic apparatus.

The first and second artificial images are images artificially generated by artificial intelligence (AI) or machine learning (ML). In other words, the first generation function F01 and the second generation function F02 are generative models (or generators) based on machine learning, and the first and second artificial images are images artificially generated by these generative models.

Several types of generative models called a GAN (Generative Adversarial Network), a VAE (Variable Autoencoder), a Diffusion Model, and an IFS (Iterated Function System) are known as generative models that can generate the first and second artificial images.

Although it is not necessarily required to specifically define what the first and second artificial images depicts or presents, at least one of the first and second artificial images (for example, the second artificial image in the case of FIG. 3) is preferably an image that depicts a specific region.

For example, the first artificial image may be a background artificial image that simulates a background of a segmentation target image, and the second artificial image may be an artificial image that simulates an image of a segmentation target region (e.g., a star-shaped region) in the segmentation target image.

In this case, the third generation function F03 generates the mixed image as the mixed data, in which the background artificial image and the specific-region artificial image are mixed, and also generates the specific-region artificial image corresponding to the segmentation target region as the mixed region information.

Note that the second artificial image is an artificial image generated in such a manner that the segmentation target region and all the other regions can be distinguished by transparency information, for example. Thus, the second artificial image is generated as an artificial image in which each pixel has four pixel values composed of respective values of three primary colors of Red, Green, and Blue and an x value representing transparency, for example. The segmentation target region can be identified by differentiating the transparency value between the segmentation target region and the other regions.

In addition, the first artificial image corresponding to the background artificial image can also be generated as an artificial image in which each pixel has four pixel values composed of respective values of the three primary colors R, G, and B and an a value representing transparency. In this case, for example, the segmentation target region can be identified from the mixed image on the basis of the difference in transparency between the first artificial image and the second artificial image.

Further, instead of using transparency information, the segmentation target region may be identified from the mixed image that is generated by mixing the first artificial image with the second artificial image where region information corresponding to the segmentation target region is added.

It is preferred that the first artificial image as the background artificial image and the second artificial image simulating the image of the segmentation target region are generated in such a manner that they are different in statistical property. For example, the first and second artificial images may be generated to be different in statistical property by at least one of the following methods: (a) having different types of generative models that respectively generate the first and second artificial images; (b) having different configuration and/or type of generation parameters used inside the respective generative models; and (c) having a pseudorandom number sequence to be inputted to the respective generative models.

The pair of the mixed image and the specific-region artificial image generated in the above-described manner by the third generation function F03 are used as training data in a first model generation function described below.

### Second Embodiment

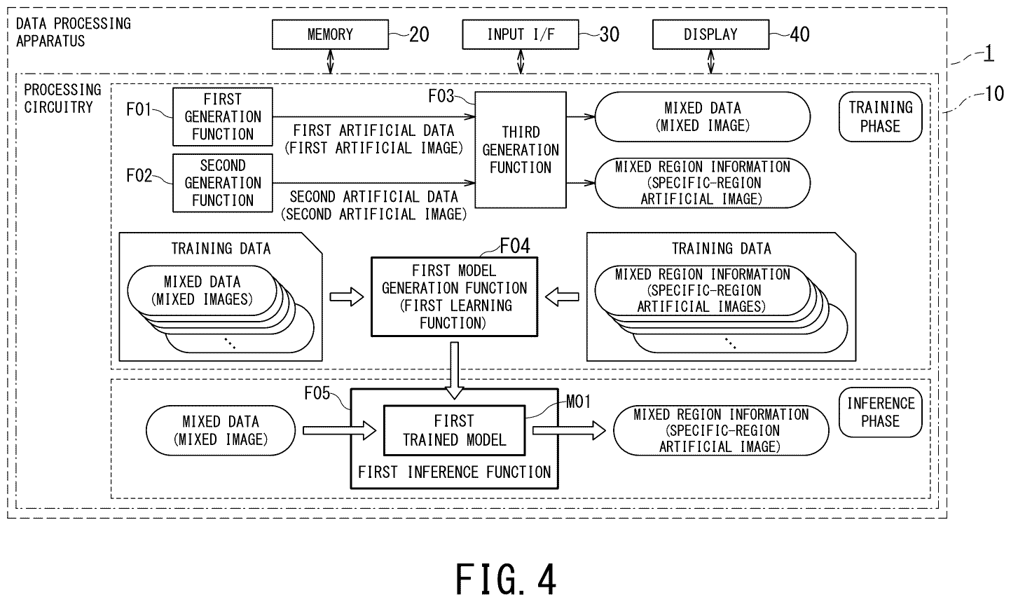

FIG. 4 is a block diagram illustrating a configuration of the data processing apparatus 1 according to the second embodiment. The data processing apparatus 1 of the second embodiment has a first trained model, which has been trained to segment a region corresponding to the second artificial image in the mixed artificial image when a mixed artificial image is inputted. The data processing apparatus 1 of the second embodiment has a function of generating this first trained model by machine learning.

As shown in FIG. 4, the data processing apparatus 1 according to the second embodiment includes the processing circuitry 10, the memory 20, the input I/F (interface) 30, and the display 40, similarly to the data processing apparatus 1 according to the first embodiment. However, the functions implemented by the processing circuitry 10 in the second embodiment differ from those in the first embodiment.

In addition to the first to third generation functions F01, F02, F03 included in the first embodiment, the processing circuitry 10 of the second embodiment further includes a first model generation function F04 and a first inference function F05.

The first generation function F01, the second generation function F02, the third generation function F03, and the first model generation function F04 are functions to be used in a training phase in machine learning, and the first inference function F05 is a function to be used in an inference phase.

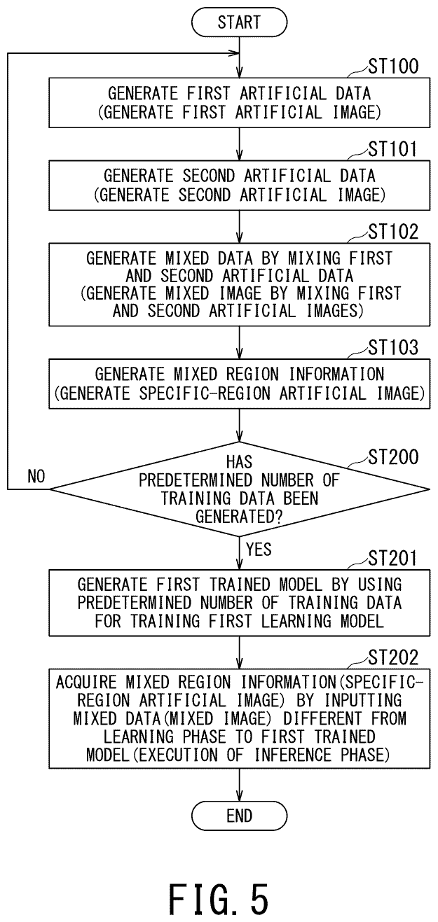

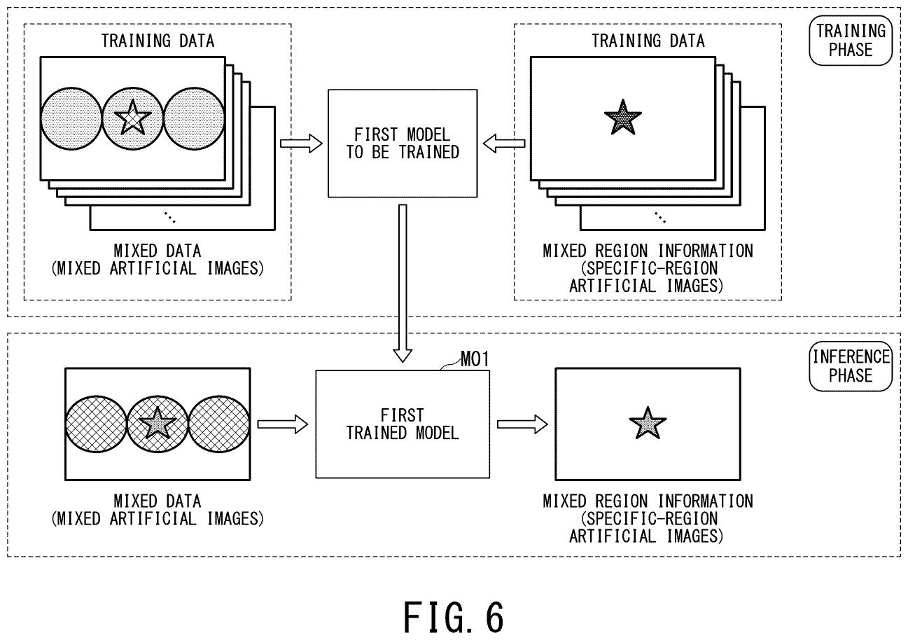

FIG. 5 is a flowchart illustrating processing performed by the data processing apparatus 1 according to the second embodiment. FIG. 6 is a schematic diagram illustrating a processing concept of the data processing apparatus 1 according to the second embodiment. Hereinbelow, each of the above-described functions will be described by using FIG. 5 and FIG. 6.

The processing from the step ST100 to the step ST201 in FIG. 5 corresponds to the processing of the training phase. In this training phase, the processing from the step ST100 to the step ST103 is the same as those in the first embodiment. In the training phase, the first to third generation functions F01, F02, F03 generate a plurality of training data respectively composed of a pair of the mixed data and the mixed region information, or generate a plurality of training data respectively composed of a pair of the mixed image and the specific-region artificial image.

In the step ST200, it is determined whether a predetermined number of training data have been generated or not. If the predetermined number of training data are not generated, the processing of the steps ST100 to ST103 is repeated until the number of generated training data reaches the predetermined number. If the number of generated training data reaches the predetermined number, the processing proceeds to the step ST201.

In the step ST201, the first model generation function F04 generates the first trained model by machine learning in which the plurality of generated mixed data and the plurality of sets of mixed region information are used as the training data. Alternatively, the first model generation function F04 generates the first trained model by machine learning in which the plurality of generated mixed images and the plurality of specific-region artificial images are used as the training data.

The upper part of FIG. 6 schematically illustrates the processing concept of the step ST201, i.e., the processing concept of the training phase. Although the type of the first learning model as the target to be trained is not limited to a specific type, it may be a machine learning model such as a neural network, for example.

The plurality of mixed data (or plurality of mixed images) shown on the upper left side of FIG. 6 are input data (or input images) such as data lack of ground truth, images without being annotated, or images without being segmented. In addition, the plurality of sets of mixed region information or the plurality of specific region images shown on the upper right side of FIG. 6 are ground truth data (or ground truth images) such as targeted region information, annotated images, or segmented images, for example.

As a result of the learning in the step ST201, the first trained model M01 shown in the lower part of FIG. 6 is generated.

The processing of the step ST202 is processing in the inference phase in machine learning. The lower diagram of FIG. 6 illustrates the operational concept of the inference phase. In the inference phase, mixed data (or a mixed image) different from those in the learning phase is inputted to the first trained model, and the mixed region information (or the specific-region artificial image) is obtained from the first trained model. For example, when a mixed artificial image like the one shown in the bottom left of FIG. 6 is inputted to the first trained model, the specific-region artificial image that has been subjected to the specific region segmentation is outputted from the first trained model. For example, the first trained model outputs the specific-region artificial image in which the specific region presented in a star-shape is segmented as shown in the bottom right of FIG. 6.

### Third Embodiment

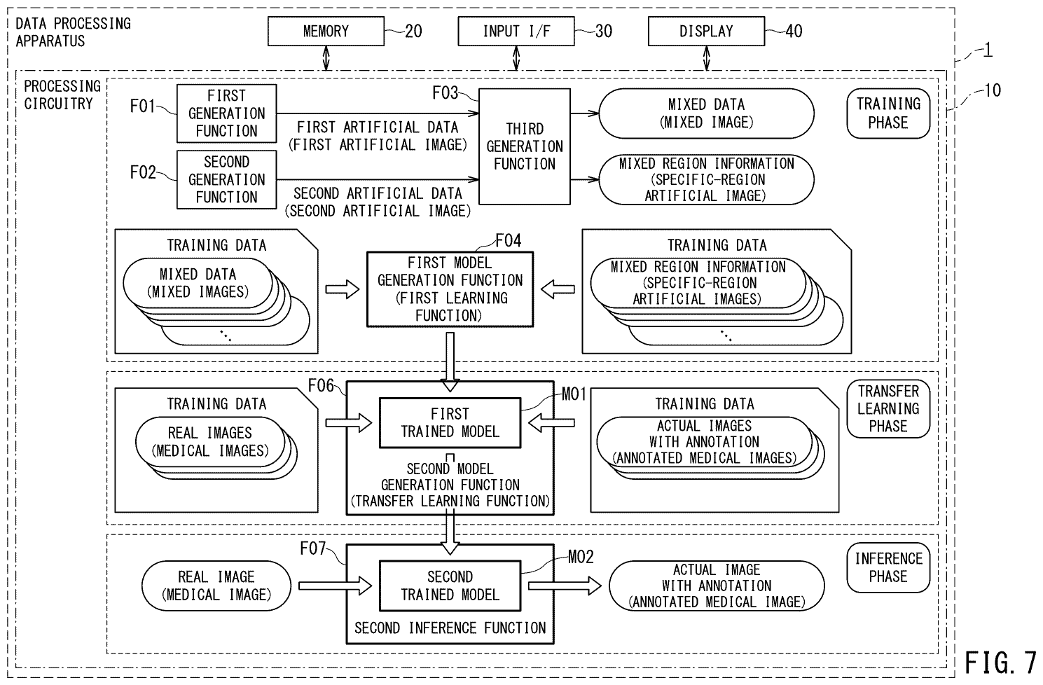

FIG. 7 is a block diagram illustrating a configuration of the data processing apparatus 1 according to the third embodiment. The data processing apparatus 1 according to the third embodiment generates a second trained model by applying transfer learning to the first trained model generated by the data processing apparatus 1 according to the second embodiment.

As shown in FIG. 7, the data processing apparatus 1 according to the third embodiment includes the processing circuitry 10, the memory 20, the input I/F (interface) 30, and the display 40, similarly to the data processing apparatus 1 according to the second embodiment.

Note that the processing circuitry 10 according to the third embodiment further includes a second model generation function F06 and a second inference function F07 in addition to the first to third generation functions F01, F02, F03 and the first model generation function F04 of the second embodiment.

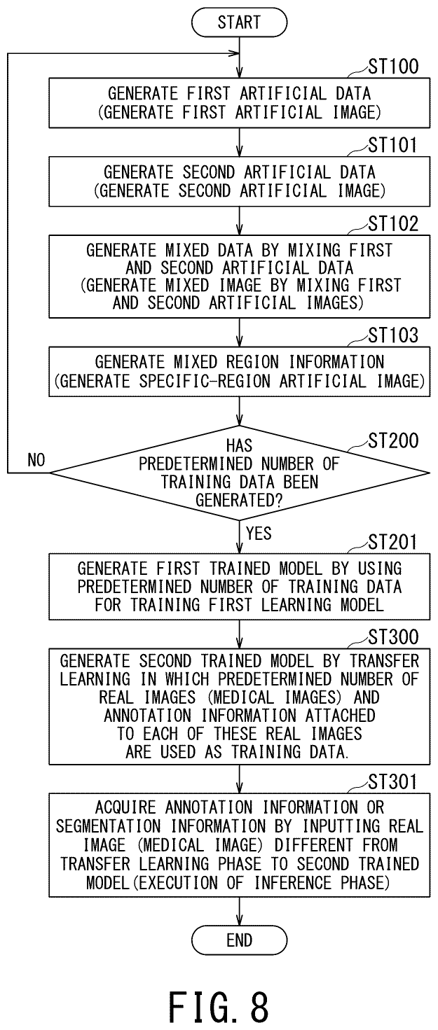

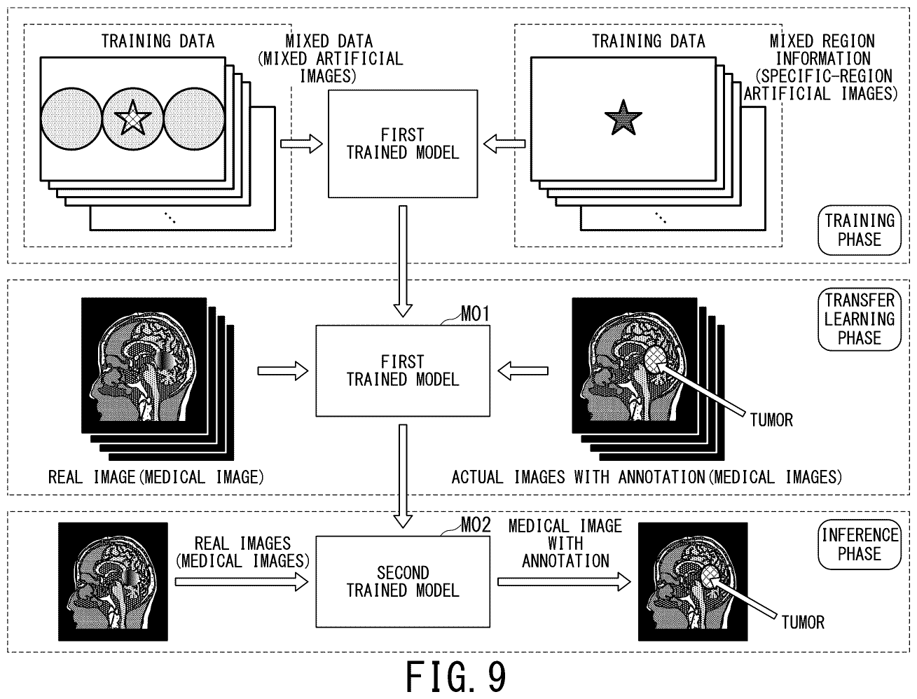

FIG. 8 is a flowchart illustrating processing to be performed by the data processing apparatus 1 according to the third embodiment. FIG. 9 schematically illustrates a processing concept of the data processing apparatus 1 according to the third embodiment. Hereinbelow, each of the above-described functions will be described by using FIG. 8 and FIG. 9.

The processing from the step ST100 to the step ST201 in FIG. 8 is the same as that in the second embodiment, and duplicate descriptions are omitted. The processing from the step ST100 to the step ST201 is the processing related to the training phase in the second embodiment. As shown in the upper part of FIG. 6, this processing is processing of generating the first trained model M01 by using the plurality of training data, which are composed of the plurality of mixed data (or the plurality of mixed artificial images) and the plurality of sets of mixed region information (or the plurality of the specific-region artificial images) corresponding to the respective mixed data.

In the step ST300, the second model generation function F06 generates a second trained model M02 by transfer learning in which a predetermined number of real images and annotation information added to each of the plurality of real images are used as training data. Alternatively, in the step ST300, the second model generation function F06 generates the second trained model M02 by transfer learning in which a plurality of medical images and segmentation information added to each of the plurality of medical images are used as the training data. The transfer learning is, for example, a technique of applying knowledge in one domain to learning in another domain. For example, the transfer learning is a machine learning method in which a trained model for one task is used as a starting point for a model to execute another task.

The middle part of FIG. 9 illustrates a concept of processing in which the second trained model M02 is being generated by applying the transfer learning to the first trained model M01, which is generated from artificial data or artificial images, using medical images without annotations (i.e., real images) and medical images with annotations corresponding to the respective real images.

The medical images used as input data for the transfer learning are images obtained by imaging an actual patient with the use of a medical image diagnostic apparatus such as an MRI apparatus, an X-ray CT apparatus, or an ultrasonic diagnostic apparatus. The annotated medical images serving as the ground truth data used in the transfer learning are images generated by having a user such as a doctor interpret the medical images and adding annotation information such as a disease name and/or a disease site (e.g., a tumor site) to each medical image, for example.

The step ST301 in FIG. 8 is processing in the inference phase in which the second trained model M02 generated by the transfer learning is used. In the inference phase, a real image (or medical image) different from the images used in the transfer learning phase is inputted to the second trained model M02 to acquire annotation information (or segmentation information), or acquire an annotated image (or segmented image).

The bottom part of FIG. 9 illustrates the processing concept of the inference phase. In this illustration, for example, a medical image (e.g., an MR image) of the head of a certain patient is inputted to the second trained model M02, and an annotated medical image is resultantly outputted. For example, a medical image with annotations indicating a suspicion of a tumor in the brain and the location of the suspected tumor is outputted.

According to the data processing apparatus 1 of the third embodiment described above, the first trained model M01 is trained by using artificial data (or artificial images) generated through a machine learning model such as a GAN, a VAE, a Diffusion Model, and an IFS as the training data. Thus, there is no particular limit to the number of training data, and the number of training data to be generated can be as many as desired. For example, it is easy to generate one million training data.

In the transfer learning phase, the training data are composed of real medical images obtained by actually imaging a patient and processed medical images obtained by adding annotation information as a diagnosis result by a doctor or another expert to the real medical images. Hence, generating training data is costly and time-consuming, and consequently, the number of training data in the transfer learning phase is limited.

In general, in the case of generating a trained model from scratch, accuracy of the trained model becomes lower as the number of training data is smaller, which lowers the probability of deriving the correct answer. However, in the data processing apparatus 1 according to the third embodiment, the second trained model M02, which is used for the diagnosis at later stage, is generated by applying the transfer learning to the first trained model M01, which has been trained by using a huge amount of artificial data (e.g., more than one million artificial data). Thus, even if the number of actual medical images and annotated medical images used for the transfer learning is a small number such as around 1000, the accuracy of the second trained model M02 used at later stage can be enhanced, and a highly reliable result can be derived from the second trained model M02.

According to the data processing apparatus of each embodiment described above, training data for machine learning, such as a huge amount of training data for generating a machine learning model for segmentation, can be generated at low cost.

While certain embodiments have been described, these embodiments have been presented by way of example only, and are not intended to limit the scope of the invention. Indeed, the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A data processing apparatus comprising processing circuitry configured to:
generate first artificial data;
generate second artificial data;
generate mixed data by mixing the first artificial data and the second artificial data; and
generate mixed region information related to a region where the first artificial data and the second artificial data are mixed.

2. The data processing apparatus according to claim 1, wherein the mixed data and the mixed region information are training data for training a machine learning model.

3. The data processing apparatus according to claim 1, wherein:
the first artificial data are first artificial images;
the second artificial data are second artificial images; and
the mixed data are mixed artificial images in which the first artificial images and the second artificial images are respectively mixed.

4. The data processing apparatus according to claim 1, wherein:
the processing circuitry is configured to generate the first artificial data and the second artificial data, by using respective generative models based on machine learning; and
a generative model used for generating the first artificial data and another generative model used for generating the second artificial data are different from each other in at least one of (a) type of the generative model, (b) a generation parameter used inside the respective generative models, and (c) a pseudorandom number sequence inputted to the respective generative models.

5. The data processing apparatus according to claim 1, wherein:
the processing circuitry is configured to generate a first artificial image and a second artificial image, by using respective generative models based on machine learning; and
a generative model used for generating the first artificial image and another generative model used for generating the second artificial image are different from each other in at least one of (a) type of the generative model, (b) a generation parameter used inside the respective generative models, and (c) a pseudorandom number sequence inputted to the respective generative models.

6. The data processing apparatus according to claim 3, wherein:
the first artificial image is a background artificial image that simulates a background of a segmentation target image;
the second artificial image is an artificial image that simulates an image of a segmentation target region in the segmentation target image; and
the processing circuitry is configured to
generate, as the mixed artificial image, an image in which the background artificial image and a simulated artificial image are mixed and
generate, as the mixed region information, a specific-region artificial image corresponding to the segmentation target region.

7. The data processing apparatus according to claim 6, wherein the second artificial image is a specific-region artificial image generated in such a manner that the segmentation target region and other regions can be distinguished by transparency information.

8. The data processing apparatus according to claim 6, wherein the processing circuitry is configured to generate the mixed artificial image by mixing the first artificial image with the second artificial image where the region information is added, using the first artificial image, the second artificial image, and region information corresponding to a segmentation target region defined for the second artificial image.

9. The data processing apparatus according to claim 6, wherein the background artificial image and the artificial image that simulates an image of the segmentation target region are generated to be different in statistical property.

10. The data processing apparatus according to claim 3, further comprising a first trained model that has been trained to segment a region corresponding to the second artificial image in the mixed artificial image when the mixed artificial image is inputted.

11. The data processing apparatus according to claim 1, wherein the processing circuitry is configured to further generate a first trained model by machine learning in which a plurality of mixed data generated in advance and a plurality of sets of the mixed region information generated in advance are used as training data.

12. The data processing apparatus according to claim 6, wherein the processing circuitry is configured to further generate a first trained model by machine learning in which a plurality of background artificial images generated in advance and a plurality of sets of specific region images generated in advance are used as training data.

13. The data processing apparatus according to claim 11, wherein the processing circuitry is configured to further generate a second trained model by applying transfer learning to the first trained model, the transfer learning being learning in which a plurality of real images and annotation information added to each of the plurality of real images are used as training data.

14. The data processing apparatus according to claim 12, wherein the processing circuitry is configured to further generate a second trained model by applying transfer learning to the first trained model, the transfer learning being learning in which a plurality of medical images and segmentation information added to each of the plurality of medical images are used as training data.

15. The data processing apparatus according to claim 1, wherein the processing circuitry is configured to generate the first artificial data and the second artificial data by using a machine learning model capable of generating artificial images, the machine learning model including at least one of a GAN (Generative Adversarial Network), a VAE (Variable Autoencoder), a Diffusion Model, and an IFS (Iterated Function System).

16. A medical image processing apparatus comprising the data processing apparatus according to claim 1.

17. A data processing method comprising:
generating first artificial data;
generating second artificial data;
generating mixed data by mixing the first artificial data and the second artificial data; and
generating a mixed region information related to a region in which the first artificial data and the second artificial data are mixed.
